(19) United States
(12) Patent Application Publication
(10) Pub. No.: US 2008/0048857 A1
(43) Pub. Date: Feb. 28, 2008

(54) RFID affected by sensor event

(75) Inventors: Kristopher C. Billmaier, Kirkland, WA (US); James A. Billmaier, Woodinville, WA (US); David P. Billmaier, Woodinville, WA (US); John M. Kellum, Woodinville, WA (US)

Correspondence Address: FSP LLC, P.O. BOX 890, VANCOUVER, WA, 98666, US

(73) Assignee: Patent Navigation Inc., Woodinville, WA (US)

(21) Appl. No.: 11/811,314

(22) Filed: Jun. 8, 2007

Related U.S. Application Data
(60) Provisional application No. 60/812,369, filed on Jun. 8, 2006.

(51) Int. Cl. H04B 7/00

(52) U.S. Cl. 340/539.26

(57) ABSTRACT

An RFID tag includes a writable memory, and a sensor coupled to persistently affect the writable memory when one or more environmental factors define one or more events of interest.

### PRIORITY CLAIM

The present application claims priority to U.S. provisional patent application RFID AFFECTED BY SENSOR EVENT, having application No. 60/812369, filed on Thursday, Jun. 8, 2006, which is incorporated herein by reference.

### TECHNICAL FIELD

The present disclosure relates to RFID tags and sensors.

### BACKGROUND

RFID tags have proven useful for tracking the motion and location of inventory. One limitation of conventional RFID tags is that they provide no or limited information about events that may affect the quality of the inventory that is tracked.

### SUMMARY

The following summary is intended to highlight and introduce some aspects of the disclosed embodiments, but not to limit the scope of the claims. Thereafter, a detailed description of illustrated embodiments is presented, which will permit one skilled in the relevant art to make and use various embodiments.

An RFID tag may include and/or involve a writable memory, and a sensor coupled to persistently affect the writable memory when one or more environmental factors define one or more events of interest. The sensor may affect the identification value returned when the RFID is read, and/or data values that are separate from the identification value of the RFID. The RFID tag may be physically coupled to the sensor. In some applications, the sensor is a thermocouple.

The sensor may persistently affect the writable memory when one or more of temperature, radiation, sound, light, shock, vibration, pressure, humidity, moisture, or altitude define one or more events of interest. The sensor may change the identification value of the RFID to fall into a range of either acceptable or unacceptable values, for example by affecting one or more high order bits of the identification value.

Other system/method/apparatus aspects are described in the text (e.g., detailed description and claims) and drawings forming the present application.

### BRIEF DESCRIPTION OF THE DRAWINGS

In the drawings, the same reference numbers and acronyms identify elements or acts with the same or similar functionality for ease of understanding and convenience. To easily identify the discussion of any particular element or act, the most significant digit or digits in a reference number refer to the figure number in which that element is first introduced.

FIG. 1 is a block diagram of an embodiment of a RFID and sensor arrangement to record events.

FIG. 2 is a flow chart of an embodiment of a process of recording events using an RFID and sensor arrangement.

FIG. 3 is a flow chart of an embodiment of a process of determining that an item tagged with an RFID has been subjected to an event.

### DETAILED DESCRIPTION

References to “one embodiment” or “an embodiment” do not necessarily refer to the same embodiment, although they may.

Unless the context clearly requires otherwise, throughout the description and the claims, the words “comprise,” “comprising,” and the like are to be construed in an inclusive sense as opposed to an exclusive or exhaustive sense; that is to say, in the sense of “including, but not limited to.” Words using the singular or plural number also include the plural or singular number respectively. Additionally, the words “herein,” “above,” “below” and words of similar import, when used in this application, refer to this application as a whole and not to any particular portions of this application. When the claims use the word “or” in reference to a list of two or more items, that word covers all of the following interpretations of the word: any of the items in the list, all of the items in the list and any combination of the items in the list.

“Logic” refers to signals and/or information that may be applied to influence the operation of a device. Software, hardware, and firmware are examples of logic. Hardware logic may be embodied in circuits. In general, logic may comprise combinations of software, hardware, and/or firmware.

RFID and Sensor Arrangement to Record Events

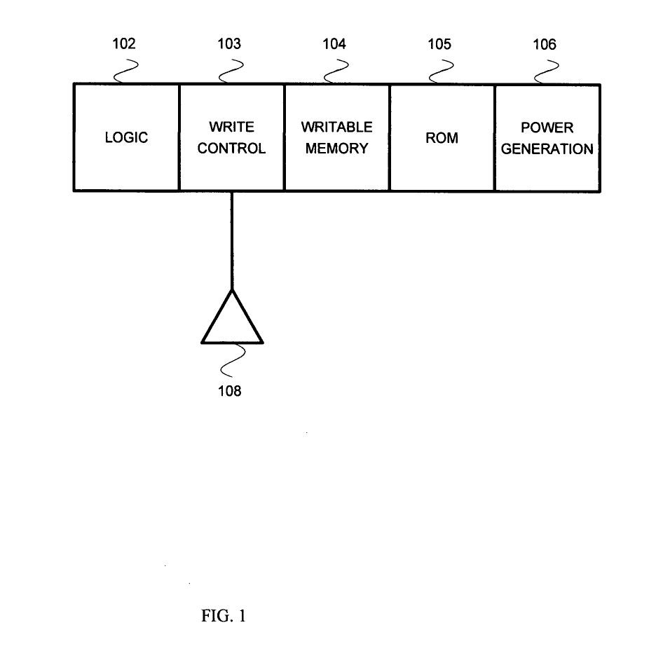

FIG. 1 is a block diagram of an embodiment of a RFID and sensor arrangement to record events.

The RFID tag arrangement includes a writable memory 104. A sensor 108 is coupled logic 102 and a write control 103 to persistently affect the writable memory 104 when one or more environmental factors define one or more events of interest.

A large variety of conditions may be recognized by the sensor and recorded within the writeable memory 104. In some cases, the sensor 108 may be used to recognize and record events that may be considered to have compromised the item being tracked by the RFID tag. For example, food within a package having the RFID tag/sensor 108 arrangement may be compromised by heat of a certain temperature range present for a certain duration. Therefore, the sensor 108 may sense temperature. The sensor output may be read by logic 102 which recognizes that a temperature condition has existed for a duration such that the package contents are compromised. Other conditions which may be measured depending on the sensor implementation to persistently affect the RFID memory 104 include radiation, sound, light, shock, vibration, humidity (presence of moisture or water), pressure, altitude, salinity, an electromagnetic signal, and presence of particulates such as dust. In temperature applications, the sensor may be a thermocouple.

In some cases, the sensor output may be used to recognize the absence of a condition. For example, packages within a truck may have attached sensors 108 which recognize a signal transmitted from somewhere within the truck. This may be the “normal” condition. Thus as long as a package is within the truck and recognizes the signal, no event may occur. If the package is removed from the truck when it should not be, the absence of the signal may trigger the recording of an event. This type of system could result in a retailer or distributor recognizing that certain goods are “gray market” or may have undergone some unplanned moves within the distribution chain.

In some cases, the logic 102 may simply recognize that an event has occurred; and, in effect, flip a bit in the writeable memory 104 of the RFID tag. In some cases, the logic 102 may choose to count the number of occurrences or record information about the event. In the example of food contents in a container having the RFID tag/sensor 108 arrangement, the package contents may contain fruit or vegetables. For certain temperature ranges and durations, when it is time to process the information captured by the RFID tag/sensor 108 arrangement an economical and safe outcome may be to select affected packages for content checking. On the other hand, if the food contents are meat, the safe outcome may be to discard the package.

The RFID tag is physically coupled to the sensor 108. In fact, in some embodiments the sensor 108 may be comprised by the RFID tag (e.g. included within the same package).

The sensor may affect the identification value returned when the RFID is read, for example by changing the identification value to fall into a range of either acceptable or unacceptable values. (This may be an example of the bit flipping approach mentioned as a possibility in some embodiments earlier.).

To accomplish this, in some embodiments the sensor may affect one or more high order bits of the identification value. For example, the RFID tag may contain a shipping container identification ANSI MH10.8.4, or other proposed standards, including the internationally recognized ISO/IEC 18000 series. There are also several major proprietary, non-standard initiatives underway to specify how RFID can be used to mark consumer goods. One such effort is the Electronic Product Code (ePC). Some leading retailers and manufacturers are also creating their own specifications that their suppliers must comply with, and like the ePC system, these initiatives are not standardized and may be based on proprietary technology. For the purpose of an example of high order bit flipping, the RFID tag may contain a value identifying the contents as having an item value of 104800 according to some system. When the sensor provides an out-of-range value on a condition, such as shock, the sensor 108/any associated logic needed 102 (in some cases this may be minimal)/the write control 103 may work together to effect a change in the high order bit so that the identification becomes 204800. Later processing may recognize this as an out-of-range i.e. unacceptable identification value and reject the associated item or cause it to be set aside for further examination.

In some embodiments, the sensor 108 may be coupled to affect data values that are separate from the identification value of the RFID. In the preceding example, the RFID identification value may be 104800 as before. When the sensor provides an out-of-range value on shock, the writeable memory may be changed to record that a shock event has occurred. However, the change may occur within a data area other than that used for item identification. Thus the RFID identification value may remain 104800 after the shock event occurrence.

The logic 102 may not be implemented to and/or the write control 103 may not be designed to write into all parts of writeable memory 104. In some cases, it may only a single bit or byte or word or a few words may be written, as in the high-order bit example provided earlier. In some cases, the RFID tag may contain certain “locked” or read only memory areas, such as ROM 105. The sensor 108/RFID arrangement may also comprise a power generation 106 means to effect sensor, logic, and memory writing.

Process of Recording Events Using an RFID and Sensor Arrangement

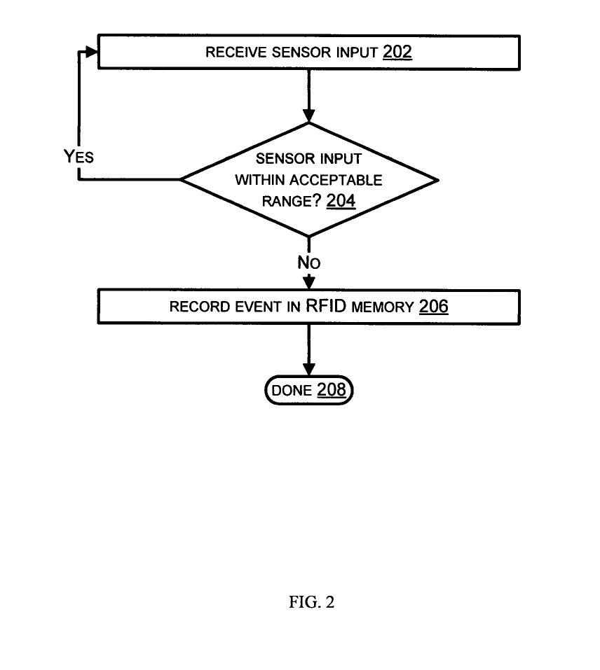

FIG. 2 is a flow chart of an embodiment of a process of recording events using an RFID and sensor arrangement. At 202, the logic may receive the sensor input. At 204, the sensor input may be examined to determine if it constitutes a writeable condition. In many implementations, such a writeable condition may be considered to be not within an acceptable range as the sensor/RFID arrangement may ultimately be used to identify items which must be examined further or discarded.

In some cases, of course, the logic may have to receive sensor inputs over a period of time or otherwise process the input to determine if a writeable condition has occurred. Such processing may include recognizing a prior event history. This may occur, because, like food spoilage, certain types of product degradation occur when a condition accumulates. A second example of such a condition is radiation, where cumulative radiation received may be as important as the occurrence of a radiation spike. For detection of such conditions, the sensor/RFID arrangement may be designed to record cumulative values either within the writeable memory or in other memory provided by the arrangement. The detection that the cumulative value has at a point in time exceeded a threshold may, in some cases, trigger the writeable event. In other implementations, the later processing of the information stored in the RFID area will determine that the stored cumulative value constitutes an out-of-range condition requiring different handling.

When the sensor input is within acceptable range (i.e., no need to record an event) the logic flow returns to 202, read sensor input. When the sensor input is not within acceptable range, at 206, the event is recorded in RFID memory.

At 208, processing is complete.

Process of Determining That an Item Tagged with an RFID has Been Subjected to an Event

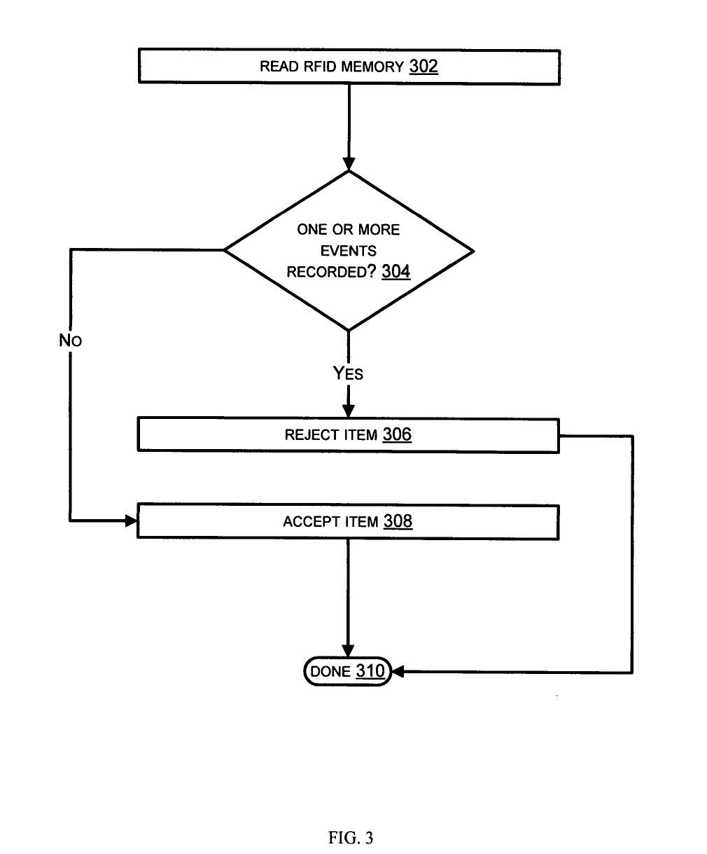

FIG. 3 is a flow chart of an embodiment of a process of determining that an item tagged with an sensor/RFID arrangement has been subjected to an event.

At 302, RFID memory is read. At 304, the processing either recognizes that one or more events have been recorded (which is a reject condition in this embodiment) or that none were recorded. If one or more events were recorded, at 306 the item is rejected; and, at 310 processing is done. If no events were recorded, at 308 the item is accepted; and, at 310 processing is complete.

One or more sensors may be coupled to an RFID tag and may adapt one or more writable values of the RFID tag upon the occurrence of one or more environmental events, and logic to read the RFID tag and to identify from the one or more writable values the occurrence of the one or more environmental events.

Logic may be employed to identify the RFID tag as having an identification value that falls within one or more rejected ranges. For example, an assembly line application or other application when items move one at a time by a RFID reader with logic attached for analysis of the results may include a means for automatically routing items to a reject bin.

The logic may identify the RFID tag as having an identification value that falls within one or more acceptable ranges. Thus items may be selected for use. Items not selected may be subject to further handling or may be rejected. For example, if the item is electronic equipment and it has been subjected to shock (or to out-of-range temperatures or moisture), it may not be selected for shipping. However, such items may then be sent to a testing area rather than rejected outright.

Those having skill in the art will appreciate that there are various vehicles by which processes and/or systems described herein can be effected (e.g., hardware, software, and/or firmware), and that the preferred vehicle will vary with the context in which the processes are deployed. For example, if an implementer determines that speed and accuracy are paramount, the implementer may opt for a hardware and/or firmware vehicle; alternatively, if flexibility is paramount, the implementer may opt for a solely software implementation; or, yet again alternatively, the implementer may opt for some combination of hardware, software, and/or firmware. Hence, there are several possible vehicles by which the processes described herein may be effected, none of which is inherently superior to the other in that any vehicle to be utilized is a choice dependent upon the context in which the vehicle will be deployed and the specific concerns (e.g., speed, flexibility, or predictability) of the implementer, any of which may vary. Those skilled in the art will recognize that optical aspects of implementations may involve optically-oriented hardware, software, and or firmware.

The foregoing detailed description has set forth various embodiments of the devices and/or processes via the use of block diagrams, flowcharts, and/or examples. Insofar as such block diagrams, flowcharts, and/or examples contain one or more functions and/or operations, it will be understood as notorious by those within the art that each function and/or operation within such block diagrams, flowcharts, or examples can be implemented, individually and/or collectively, by a wide range of hardware, software, firmware, or virtually any combination thereof. Several portions of the subject matter described herein may be implemented via Application Specific Integrated Circuits (ASICs), Field Programmable Gate Arrays (FPGAs), digital signal processors (DSPs), or other integrated formats. However, those skilled in the art will recognize that some aspects of the embodiments disclosed herein, in whole or in part, can be equivalently implemented in standard integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and/or firmware would be well within the skill of one of skill in the art in light of this disclosure. In addition, those skilled in the art will appreciate that the mechanisms of the subject matter described herein are capable of being distributed as a program product in a variety of forms, and that an illustrative embodiment of the subject matter described herein applies equally regardless of the particular type of signal bearing media used to actually carry out the distribution. Examples of a signal bearing media include, but are not limited to, the following: recordable type media such as floppy disks, hard disk drives, CD ROMs, digital tape, and computer memory; and transmission type media such as digital and analog communication links using TDM or IP based communication links (e.g., packet links).

In a general sense, those skilled in the art will recognize that the various aspects described herein which can be implemented, individually and/or collectively, by a wide range of hardware, software, firmware, or any combination thereof can be viewed as being composed of various types of “electrical circuitry.” Consequently, as used herein “electrical circuitry” includes, but is not limited to, electrical circuitry having at least one discrete electrical circuit, electrical circuitry having at least one integrated circuit, electrical circuitry having at least one application specific integrated circuit, electrical circuitry forming a general purpose computing device configured by a computer program (e.g., a general purpose computer configured by a computer program which at least partially carries out processes and/or devices described herein, or a microprocessor configured by a computer program which at least partially carries out processes and/or devices described herein), electrical circuitry forming a memory device (e.g., forms of random access memory), and/or electrical circuitry forming a communications device (e.g., a modem, communications switch, or optical-electrical equipment).

Those skilled in the art will recognize that it is common within the art to describe devices and/or processes in the fashion set forth herein, and thereafter use standard engineering practices to integrate such described devices and/or processes into larger systems. That is, at least a portion of the devices and/or processes described herein can be integrated into a network processing system via a reasonable amount of experimentation.

The foregoing described aspects depict different components contained within, or connected with, different other components. It is to be understood that such depicted architectures are merely exemplary, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality.

What is claimed is:

1. A RFID tag comprising:
a writable memory; and
a sensor coupled to persistently affect the writable memory when one or more environmental factors define one or more events of interest.

2. The RFID tag of claim 1, wherein the a sensor coupled to persistently affect the writable memory when one or more environmental factors define one or more events of interest further comprises:
the sensor affecting the identification value returned when the RFID is read.

3. The RFID tag of claim 2, wherein sensor affecting the identification value returned when the RFID is read further comprises:
the sensor changing the identification value to fall into a range of either acceptable or unacceptable values.

4. The RFID tag of claim 3, wherein sensor changing the identification value to fall into a range of either acceptable or unacceptable values further comprises:
the sensor affecting one or more high order bits of the identification value.

5. The RFID tag of claim 1, wherein the a sensor coupled to persistently affect the writable memory when one or more environmental factors define one or more events of interest further comprises:
the sensor coupled to affect data values that are separate from the identification value of the RFID.

6. The RFID tag of claim 1, wherein the a sensor coupled to persistently affect the writable memory when one or more environmental factors define one or more events of interest further comprises:
the RFID tag physically coupled to the sensor.

7. The RFID tag of claim 1, wherein the a sensor coupled to persistently affect the writable memory when one or more environmental factors define one or more events of interest further comprises:
the sensor is a thermocouple.

8. The RFID tag of claim 1, wherein the a sensor coupled to persistently affect the writable memory when one or more environmental factors define one or more events of interest further comprises:
the sensor persistently affecting the writable memory when one or more of temperature, radiation, sound, light, shock, vibration, pressure, humidity, moisture, or altitude define one or more events of interest.

9. A method comprising:
one or more sensors coupled to an RFID tag adapting one or more writable values of the RFID tag upon the occurrence of one or more environmental events; and
logic to read the RFID tag and to identify from the one or more writable values the occurrence of the one or more environmental events.

10. The method of claim 9, wherein the logic to read the RFID tag and to identify from the one or more writable values the occurrence of the one or more environmental events further comprises:
logic to identify the RFID tag as having an identification value that falls within one or more rejected ranges.

11. The method of claim 9, wherein the logic to read the RFID tag and to identify from the one or more writable values the occurrence of the one or more environmental events further comprises:
logic to identify the RFID tag as having an identification value that falls within one or more acceptable ranges.
